(19) United States
(12) Patent Application Publication
(10) Pub. No.: US 2012/0180394 A1
(43) Pub. Date: Jul. 19, 2012

(54) POWER WINDOW APPARATUS

(76) Inventor: Akihiko Shinohara, Miyagi-ken (JP)

(21) Appl. No.: 13/349,248

(22) Filed: Jan. 12, 2012

(30) Foreign Application Priority Data
Jan. 13, 2011 (JP) 2011-004775

(51) Int. Cl. E05F 15/08

(52) U.S. Cl. 49/349

(57) ABSTRACT

A power window apparatus includes a movable member, a motor, a pulse generator that generates a pulse as the motor rotates, and a controller. The controller includes a reference position setting unit that sets a pulse reference value corresponding to a reference position, a position detecting unit that detects a level of the height of the movable member on the basis of pulses, a lock detecting unit that, on the basis of pulses, detects a locked or unlocked state of the motor, a pinch detecting unit that, in the case where the locked state of the motor is detected, determines, on the basis of whether the level of the height of the movable member is positioned in a non-detection area, whether the movable member has reached the upper-end lock position or a pinch has occurred, and a voltage detecting unit that detects a driving voltage applied to the motor.

### CLAIM OF PRIORITY

This application claims benefit of Japanese Patent Application No. 2011-004775 filed on Jan. 13, 2011, which is hereby incorporated by reference.

### BACKGROUND OF THE INVENTION

1. Field of the Invention

The present invention relates to a power window apparatus that opens and closes a pane or the like of an automobile with electric power, and in particular, relates to a power window apparatus having a pinch detecting function.

2. Description of the Related Art

Power window apparatuses for opening and closing a pane or the like with electric power have been widely used in automobiles. A typical power window apparatus has a pinch detecting function capable of detecting a pinch of a foreign object between a pane and a frame of a window. The pinch detecting function is realized by detection of a change in torque of a motor driving the pane. In the case where a pinch is detected, control is performed such that raising the pane is stopped and the direction of rotation of the motor is reversed in order to lower the pane.

In the case where the pane of the automobile is raised such that the pane is closed, when the pane comes into contact with the upper end of the window, the torque of the motor changes. In order to distinguish this case from a case where a pinch has occurred, a predetermined range extending from the upper end of the window is set to a non-detection area in which if the torque of the motor changes, a pinch is not determined. The width of the non-detection area is set so that the above-described two cases can be reliably distinguished from each other. If the non-detection area can be reduced, a pinch of a thinner foreign object can be detected. Accordingly, the accuracy of pinch detection can be increased.

In the pinch detecting function, a change in torque is detected in response to a change in pulse period measured by a pulse measuring unit attached to the motor. During normal rotation of the motor, a distance of movement of the pane for each pulse period is previously known. Accordingly, a distance of movement of the pane can be detected. When a pinch occurs or the pane comes into contact with the upper end of the window, the number of rotations of the motor decreases, so that the pulse period measured by the pulse measuring unit increases. In order to determine whether the pane is positioned in the non-detection area upon decrease of the number of rotations of the motor, the position of the pane relative to the upper end of the window has to be detected.

For this reason, the position of the pane in contact with the upper end of the window is previously set as a reference position. When the pane is opened or closed, an amount of change from the reference position is counted in order to detect the position of the pane relative to the upper end of the window. The reference position of the pane is reset each time the pane comes into contact with the upper end of the window. An example of the power window apparatus that detects a pinch while setting the non-detection area is disclosed in Japanese Patent No. 3455319.

When the pane comes into contact with the upper end of the window, the position of the pane does not change further but the motor slightly rotates under the influence of damper characteristics and then stops. When a stop position of the motor is set to the above-described reference position, the reference position differs from an actual position of the pane. If the amount of difference between the positions is constant at all times, any problems will not occur. Actually, however, a locked-rotor torque changes depending on a voltage applied to the motor. Accordingly, the amount of difference between the positions is also affected by the voltage.

Electric power is supplied to the motor from a battery of the automobile. A voltage fluctuates depending on a condition of the automobile, for example, whether the engine has started, alternatively, whether another device uses the battery. Consequently, the reference position of the pane varies depending on a condition of the automobile. In order to reliably distinguish a pinch from the contact with the upper end of the window, it is difficult to significantly reduce the non-detection area. In other words, it is difficult to increase the accuracy of pinch detection. To solve such a problem, according to an apparatus disclosed in Japanese Patent No. 3455319, the non-detection area is reset on the basis of a moving speed of the pane.

Of importance to increase the accuracy of pane position detection is the extent to which the reference position differs from an actual position of the pane when the pane comes into contact with the upper end of the window. If the non-detection area is reset on the basis of a moving speed of the pane while the difference between the positions is being left, it is difficult to accurately set the non-detection area.

### SUMMARY OF THE INVENTION

The present invention has been made in consideration of the above problems and provides a power window apparatus with increased accuracy of pinch detection realized by accurately setting a reference position of a pane to reduce a non-detection area.

According to an aspect of the present invention, a power window apparatus includes a movable member that constitutes a window of a vehicle, a motor that drives the movable member, a pulse generator that generates a pulse as the motor rotates, and a controller that controls the motor. The controller includes a reference position setting unit that sets a pulse reference value corresponding to an upper-end lock position, serving as a reference position of the movable member, a position detecting unit that detects a level of the height of the movable member relative to the reference position by adding the number of pulses from the pulse generator to the pulse reference value corresponding to the reference position, a lock detecting unit that, on the basis of the period of pulses from the pulse generator, detects a locked or unlocked state of the motor, a pinch detecting unit that, in the case where the lock detecting unit detects the locked state of the motor, determines, on the basis of whether the level of the height of the movable member detected by the position detecting unit is positioned in a non-detection area set near the reference position, whether the movable member has reached the upper-end lock position or a pinch has occurred in the movable member, and a voltage detecting unit that detects a driving voltage applied to the motor. In the case where the pinch detecting unit determines that the movable member has reached the upper-end lock position, the reference position setting unit corrects the pulse reference value on the basis of the driving voltage applied to the motor detected by the voltage detecting unit and sets the corrected value.

Advantageously, even if the driving voltage applied to the motor varies, the error between an actual position of the movable member and the position thereof detected on the basis of the number of pulses can be reduced. Thus, the accuracy of detection of the position of the movable member can be increased. If a narrow non-detection area is set, malfunction can be prevented and the pinch of a thinner object can be detected.

In this aspect, the reference position setting unit may calculate, on the basis of a previously measured relationship between a voltage at the upper-end lock position and a difference in the number of pulses relative to the pulse reference value at a reference voltage, a difference in the number of pulses associated with the driving voltage applied to the motor detected by the voltage detecting unit, add the calculated difference in the number of pulses to the pulse reference value at the reference voltage, and set the obtained value as the pulse reference value at the driving voltage.

Advantageously, the upper-end lock position can be corrected and set by processing of pulse signals from the pulse generator. This can be realized by simple processing.

In this aspect, the controller may further include an area setting unit that sets a pulse value corresponding to the position of the lower end of the non-detection area. While the movable member is being driven so as to be closed, the area setting unit corrects the pulse value corresponding to the lower end position of the non-detection area on the basis of the driving voltage applied to the motor detected by the voltage detecting unit and sets the corrected pulse value.

Advantageously, a pinch can be detected with higher accuracy than a case where the lower end position of the non-detection area is set on the basis of a pulse reference value corresponding to a reference position set at the last time when the movable member was opened or closed. Accordingly, even if a narrower non-detection area is set, malfunction can be prevented and the pinch of a thinner object can be detected.

In this aspect, the area setting unit may calculate, on the basis of a previously measured relationship between a voltage at the upper-end lock position and a difference in the number of pulses relative to the pulse reference value at a reference voltage, a difference in the number of pulses associated with the driving voltage applied to the motor detected by the voltage detecting unit, add the calculated difference in the number of pulses to the pulse value corresponding to the lower end position of the non-detection area at the reference voltage, and set the obtained value as the pulse value corresponding to the lower end position of the non-detection area at the driving voltage.

Advantageously, the upper-end lock position can be corrected and set by processing of pulse signals from the pulse generator. This can be achieved by simple processing.

### BRIEF DESCRIPTION OF THE DRAWINGS

FIG. 1 is a schematic diagram of a configuration of a power window apparatus according to an embodiment of the present invention;

FIG. 2 is a block diagram of a configuration of a mechanism for controlling a motor;

FIG. 3 is a timing diagram of pulse signals from pulse generators;

FIGS. 4A and 4B are enlarged cross-sectional views of an upper end of a movable member and an upper sash;

FIG. 5 is a graph illustrating the relationship between a driving voltage applied to a motor and the difference between an actual upper-end lock position and a reference position based on the detected number of pulses;

FIG. 6 is a flowchart of pinch detection and reference position setting during raising of the movable member; and

FIG. 7 is a graph illustrating the relationship between a voltage and the number of pulses in correction of the position of the lower end of a non-detection area.

### DESCRIPTION OF THE PREFERRED EMBODIMENTS

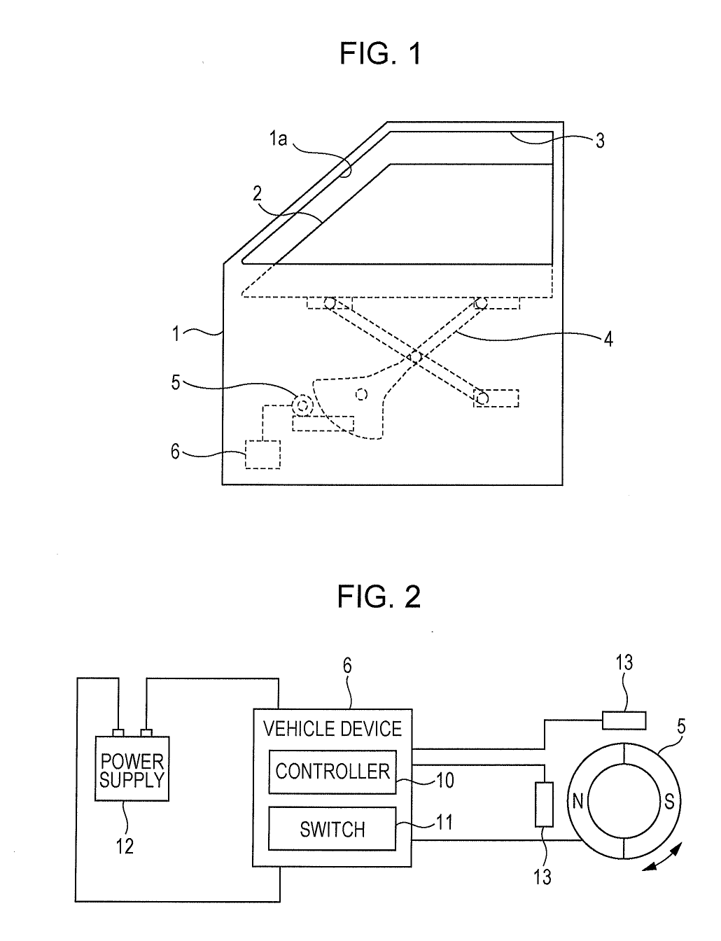

An embodiment of the present invention will be described in detail with reference to the drawings. FIG. 1 is a schematic diagram of a configuration of a power window apparatus according to the present embodiment. The power window apparatus according to this embodiment includes a movable member 2, serving as a pane, provided for a door 1 of a vehicle, such as an automobile, a window driving unit 4 that includes a motor 5 for raising and lowering the movable member 2, and a vehicle device 6 that controls the window driving unit 4. Although in FIG. 1 the vehicle device 6 is illustrated in the door 1 for the sake of convenience, the device may be disposed at any position in the vehicle.

The door 1 has an opening la. This opening la is opened and closed by upward and downward movements of the movable member 2. As the movable member 2 is lowered, the opening la is opened. As the movable member 2 is raised, the opening la is closed. When the movable member 2 is raised to an upper end position, the opening la is completely closed. At this time, the upper side of the movable member 2 comes into contact with an upper sash 3 constituting the upper side of the door 1.

The window driving unit 4 is received in the door 1 and is linked to the movable member 2, such that the unit can move the member upward and downward. A power source for movement is the motor 5 provided for the window driving unit 4. The motor 5 is rotatable both forward and backward. The rotation of the motor 5 in one direction causes the movable member 2 to be driven upward and the rotation thereof in the other direction causes the movable member 2 to be driven downward. Controlling the rotation of the motor 5 enables opening and closing of the opening la to be controlled with the movable member 2.

FIG. 2 illustrates a mechanism for controlling the motor 5. Two pulse generators 13 are arranged around the motor 5. The pulse generators 13 may be built in or externally attached to the motor 5. The pulse generators 13 are each configured to generate a pulse signal as the motor 5 rotates. As regards pulse signals from the pulse generators 13, since a signal is generated each time the motor 5 rotates by a predetermined angle, the number of pulse signals is counted, thus measuring the amount of rotation of the motor 5. In addition, the period of pulse signals is detected, thus measuring a rotational speed of the motor 5.

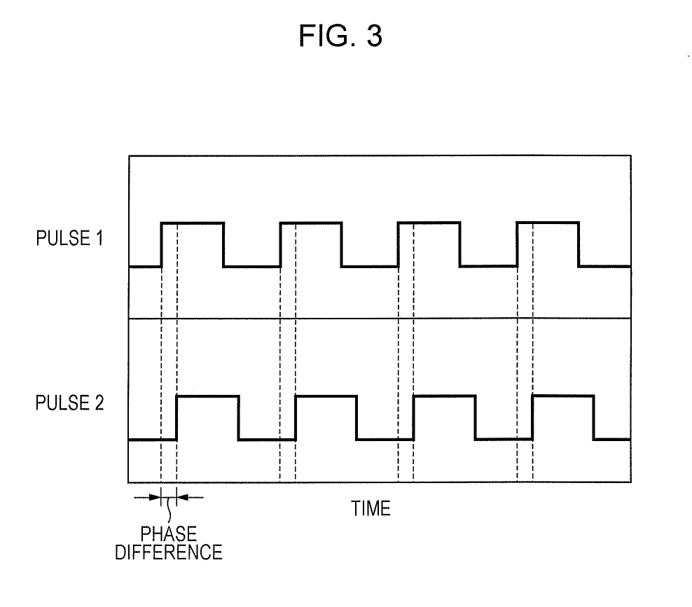

FIG. 3 illustrates pulse signals from the pulse generators 13. Referring to FIG. 3, a pulse 1 represents a pulse signal from one of the two pulse generators 13 and a pulse 2 represents a pulse signal from the other pulse generator 13. As the motor 5 rotates, the two pulse generators 13 generate signals different only in phase. The direction of rotation of the motor 5 can be determined on the basis of whether the difference in phase between the pulse signals is positive or negative relative to either of the pulse signals as a reference. In the following description, it is assumed that the direction in which the movable member 2 is lowered is a forward direction and the direction in which the movable member 2 is raised is a negative direction.

The vehicle device 6 performs power supply control for the motor 5 and processing of the pulse signals from the pulse generators 13. The vehicle device 6 includes a switch 11 disposed in the interior of the vehicle and a controller 10 that performs various controls. The controller 10 controls the motor 5 in accordance with an operation of the switch 11 and processes the pulse signals from the pulse generators 13. When determining the occurrence of a pinch between the movable member 2 and the upper sash 3 (hereinafter, also referred to as a “pinch in the movable member 2”), alternatively, when the movable member 2 reaches an upper-end lock position, the controller 10 automatically controls the motor 5.

The vehicle device 6 is supplied with electric power from a power supply 12. This power allows the motor 5 to be driven. Since the power supply 12 is a typical automobile battery, a voltage fluctuates depending on a condition of the vehicle, for example, whether the engine has operated, or, whether another device, such as an air conditioner, has operated. In this embodiment, it is assumed that a reference voltage is 12 V and the voltage fluctuates in the range of about 10 V to about 16 V.

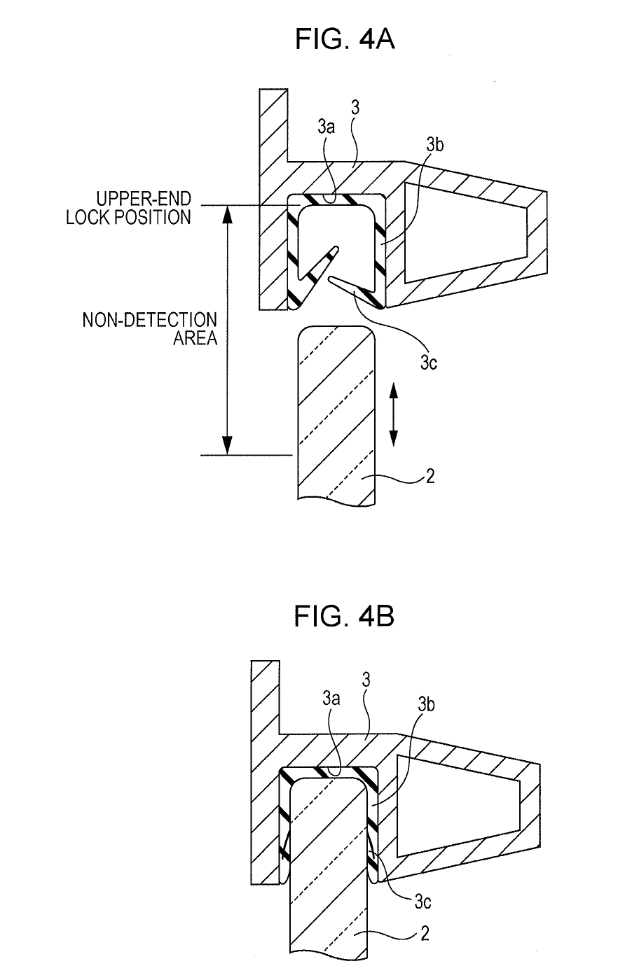

FIGS. 4A and 4B are enlarged cross-sectional views of the upper end of the movable member 2 and the upper sash 3. FIG. 4A illustrates a state in which the upper end of the movable member 2 is positioned near the upper sash 3. FIG. 4B illustrates a state in which the upper end of the movable member 2 is in contact with the upper sash 3, namely, the upper end thereof has reached the upper-end lock position. As illustrated in FIG. 4A, the upper sash 3 has a downwardly facing recess 3a, which receives a rubber airtight seal 3b that fits the recess 3a. The airtight seal 3b is generally U-shaped in cross-section such that the seal fits the recess 3a and has inwardly extending fins 3c arranged on both ends of an opening of the recess 3a. The movable member 2 has a thickness that substantially fits the width of the airtight seal 3b received in the recess 3a. Accordingly, the movable member 2 can enter a space defined by the airtight seal 3b.

In FIG. 4A, the position of the surface of the downwardly facing inner wall of the airtight seal 3b is the upper-end lock position of the movable member 2. During upward movement of the movable member 2, when the upper end face of the movable member 2 comes into contact with the inner wall of the airtight seal 3b, or reaches the upper-end lock position, the movable member is stopped. A range between the upper-end lock position and a lower position a predetermined distance away therefrom is the non-detection area in which a pinch is not determined for detection of a pinch in the movable member 2. A pinch in the movable member 2 is detected in response to detection of a sudden decrease in rotational speed corresponding to the torque of the motor 5 detected on the basis of pulse signals from the pulse generators 13. If the movable member 2 reaches the upper-end lock position, a similar decrease in rotational speed will occur. The non-detection area is therefore provided in order to distinguish between the decreases.

As described above, the distance of movement of the movable member 2 can be detected on the basis of the number of pulses generated from each pulse generator 13. Accordingly, while the movable member 2 is in the upper-end lock position, the upper-end lock position is set to a reference position and a pulse reference value corresponding to the reference position is set. The number of pulses in the positive and negative directions relative to the reference position is detected, thus detecting the position of the movable member 2.

Referring to FIG. 4B, when the upper end of the movable member 2 reaches the upper-end lock position, the fins 3c of the airtight seal 3b are deformed such that the fins are pressed in contact with the movable member 2, thus ensuring the airtightness of the interior of the vehicle. When the movable member 2 is moved upward and reaches the upper-end lock position, the movable member 2 is not moved further but the motor 5 slightly rotates depending on damper characteristics and then stops. If the movable member 2 has stopped, therefore, some pulse signals will be generated from the pulse generators 13. After that, while the motor 5 is stopping, the pulse reference value corresponding to the reference position is reset. Accordingly, a little deviation occurs between the actual upper-end lock position and the reference position based on the detected number of pulses. The non-detection area is set so as to have a certain margin in consideration of this deviation.

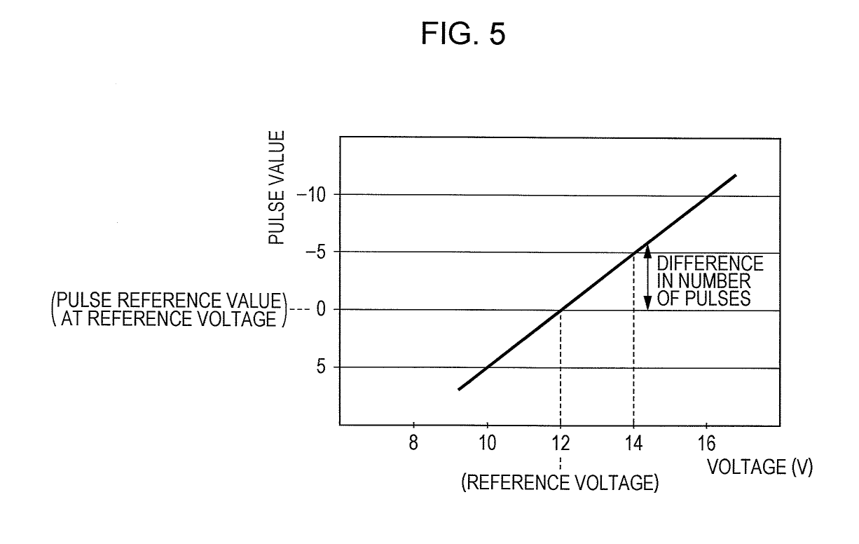

The amount of rotation of the motor 5 after the movable member 2 stops varies depending on a driving voltage applied to the motor 5. Accordingly, if the driving voltage applied to the motor 5 varies, the amount of deviation between the actual upper-end lock position and the reference position based on the detected number of pulses also changes. FIG. 5 illustrates the relationship between the driving voltage applied to the motor 5 and the deviation between the actual upper-end lock position and the reference position based on the detected number of pulses. In FIG. 5, the amount of deviation between the actual upper-end lock position and the reference position based on the detected number of pulses is represented by the number of pulses. The amount of deviation is zero at a reference voltage of 12 V.

Referring to FIG. 5, as the voltage is lower than the reference voltage, the deviation between the actual upper-end lock position and the reference position based on the detected number of pulses increases in the positive direction. On the other hand, as the voltage is higher than the reference voltage, the deviation between the actual upper-end lock position and the reference position based on the detected number of pulses increases in the negative direction. In the present embodiment, the pulse reference value may be corrected on the basis of the relationship illustrated in FIG. 5. The relationship of FIG. 5 has to be previously measured.

The controller 10 of the vehicle device 6 includes the following components to perform pinch detection and reference position setting. A position detecting unit detects the height of the movable member 2 relative to the reference position by adding the number of pulses generated from each pulse generator 13 to a pulse reference value corresponding to a reference position. A reference position setting unit sets the pulse reference value corresponding to the reference position. A lock detecting unit detects, on the basis of the period of pulses from the pulse generator 13, a locked or unlocked state of the motor 5. In the case where the lock detecting unit detects the locked state of the motor 5, a pinch detecting unit determines, on the basis of whether the height of the movable member detected by the position detecting unit is positioned in a non-detection area set near the reference position, whether the movable member has reached the upper-end lock position or a pinch has occurred in the movable member. A voltage detecting unit detects a driving voltage applied to the motor 5.

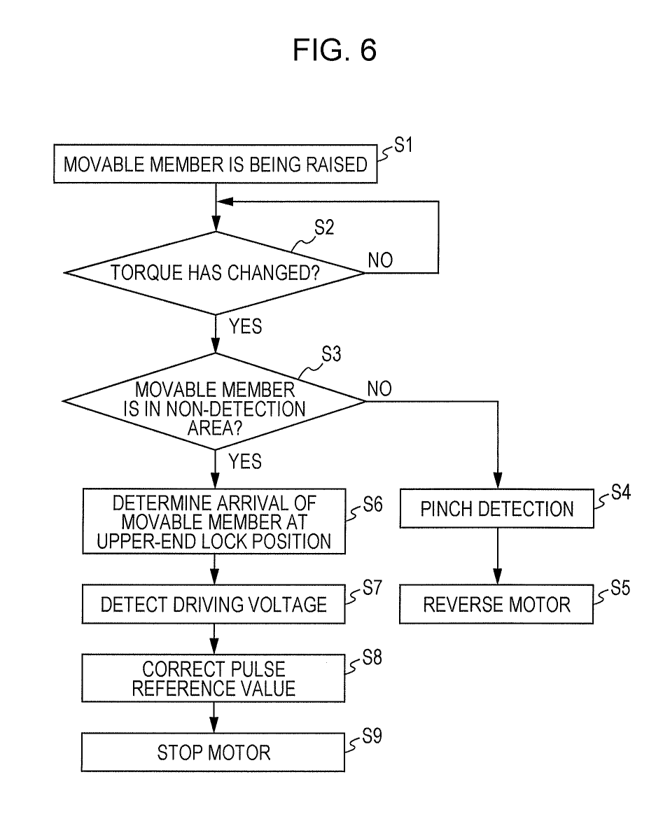

FIG. 6 is a flowchart of pinch detection and reference position setting performed while the movable member 2 is being raised. While the movable member 2 is being raised (S1), the position detecting unit counts the number of pulses from each pulse generator 13 and updates the position of the movable member 2 at any time. The lock detecting unit monitors a change in torque of the motor 5 (S2) and continues monitoring if there is no change in torque. The torque of the motor 5 is calculated using the number of rotations of the motor 5 obtained from the period of pulses from each pulse generator 13. In the case where a rate of change in torque exceeds a predetermined value, a change in torque is detected. If the torque has changed, a locked state of the motor is detected. As regards a method of detecting a change in torque, a change in torque may be detected on the basis of a rate of change in number of rotations of the motor without calculation of the torque using the period of pulses. Alternatively, a change in torque may be calculated on the basis of a current to drive the motor or a rate of change in current.

In the case where the lock detecting unit detects a change in torque, the pinch detecting unit determines whether the movable member 2 is positioned in the non-detection area (S3). In the non-detection area, a pulse value corresponding to the position of the lower end of the area has previously been set below the pulse reference value corresponding to the reference position by a predetermined number of pulses. A determination is made as to whether a pulse value corresponding to the position of the movable member 2 detected by the position detecting unit is in the range from the pulse reference value to the pulse value corresponding to the lower end position of the non-detection area. If it is determined that the movable member 2 is not positioned in the non-detection area, namely, the movable member 2 is not positioned in a region between the upper-end lock position and the lower end position below the upper-end lock position by a predetermined distance, the pinch detecting unit determines that a pinch has occurred (S4). In this case, the controller 10 performs control such that the motor 5 is reversed to lower the movable member 2 (S5). Thus, the pinch is removed.

If it is determined in S3 that the movable member 2 is positioned in the non-detection area, the pinch detecting unit determines that the movable member 2 has reached the upper-end lock position (S6). In this case, the voltage detecting unit detects a driving voltage applied to the motor 5 (S7). Subsequently, the reference position setting unit corrects the pulse reference value and sets the corrected value (S8). Since the pulse value corresponding to the lower end position of the non-detection area is set below the pulse reference value by a predetermined number of pulses as described above, this pulse value is also set in accordance with setting of the pulse reference value.

The pulse reference value is set to zero when a driving voltage applied to the motor 5 is the reference voltage (12 V). In this case, when the movable member 2 is again lowered, the number of pulses is added to zero in the positive direction. The position of the movable member 2 is detected on the assumption that the position corresponds to the added number of pulses.

As described with reference to FIG. 5, a change in driving voltage applied to the motor 5 causes a difference in the number of pulses at the upper-end lock position. Accordingly, the reference position setting unit may calculate the difference in the number of pulses associated with the driving voltage applied to the motor 5 detected in S7 by the voltage detecting unit on the basis of the relationship of FIG. 5 and set the obtained value as a pulse reference value. For example, in the case where a driving voltage applied to the motor 5 is 14 V, a difference in the number of pulses is −5. The pulse reference value is therefore set to −5. When the movable member 2 is again lowered, the number of pulses is added to −5 in the positive direction and the position of the movable member 2 is detected on the assumption that the position corresponds to the added number of pulses.

As described above, when the movable member 2 reaches the upper-end lock position, the pulse reference value is set on the basis of a driving voltage applied to the motor 5. Accordingly, if a driving voltage applied to the motor 5 varies, the error between the actual position of the movable member 2 and the position of the movable member 2 detected on the basis of the number of pulses can be reduced. Consequently, the accuracy of detection of the position of the movable member 2 can be increased. Advantageously, if a narrow non-detection area is set, malfunction can be prevented and the pinch of a thinner object can be detected.

After the pulse reference value corresponding to the upper-end lock position of the movable member 2 is set, the controller 10 stops the motor 5 (S9) and completes the control during raising of the movable member 2. The pulse reference value set in S8 is used to detect the position of the movable member 2 at the next time when the movable member 2 is opened or closed.

In the present embodiment, the pulse value corresponding to the lower end position of the non-detection area is set simultaneously with setting of the reference position. This pulse value may be corrected on the basis of a driving voltage applied to the motor 5 while the movable member 2 is being driven so as to be closed, namely, the movable member is being raised. If a pinch in the movable member 2 has occurred, the deviation between the actual position of the movable member 2 and the position of the movable member 2 detected on the basis of the number of pulses occurs depending on a driving voltage applied to the motor 5. Accordingly, the lower end position of the non-detection area is corrected on the basis of a driving voltage applied to the motor 5 during raising of the movable member 2, so that a pinch can be detected with higher accuracy. For this correction, the controller 10 may further include an area setting unit.

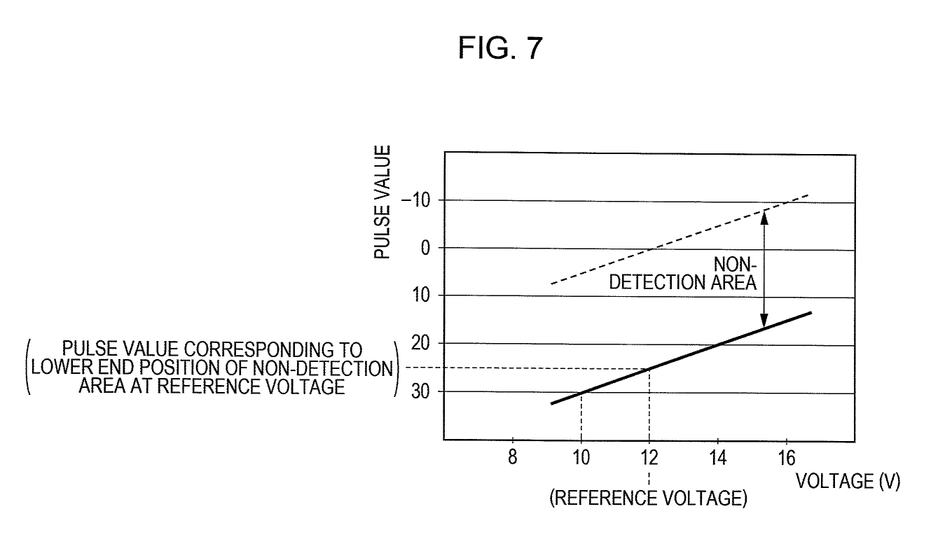

FIG. 7 illustrates the relationship between the voltage and the number of pulses in correction of the lower end position of the non-detection area. In FIG. 7, a solid line indicates a pulse value corresponding to the lower end position of the non-detection area and a broken line indicates a pulse value corresponding to the reference position. A pulse value, which corresponds to the reference position and is indicated by the broken line, corresponds to the reference position based on a driving voltage applied to the motor 5 during raising of the movable member 2. In other words, this pulse value represents a pulse reference value to be reset when the movable member 2 reaches the upper-end lock position.

In FIG. 7, the lower end position of the non-detection area is set such that the corresponding pulse value is below the pulse reference value to be reset when the movable member 2 reaches the upper-end lock position by 25 pulses. Accordingly, the pulse value corresponding to the lower end position of the non-detection area is set to 25 in the case where a driving voltage applied to the motor 5 during raising is the reference voltage (12 V).

In the case where the driving voltage applied to the motor 5 during raising, detected by the voltage detecting unit, differs from the reference voltage, a pulse value based on the driving voltage in FIG. 7 is set to a pulse value corresponding to the lower end position of the non-detection area. This setting is performed by the area setting unit during raising of the movable member 2 in S1 in FIG. 6.

For example, therefore, in the case where a driving voltage applied to the motor 5 during raising is 10 V, the area setting unit sets a pulse value corresponding to the lower end position of the non-detection area to 30. This pulse value is used to determine, in S3 in FIG. 6, whether the movable member 2 is positioned in the non-detection area. In the case where the driving voltage applied to the motor 5 is 10 V, if a pulse value corresponding to the position of the movable member 2 detected in S3 by the position detecting unit is less than 30, it is determined that the movable member 2 is positioned in the non-detection area. If this pulse value is greater than or equal to 30, it is determined that the movable member 2 is not positioned in the non-detection area.

As described above, a pulse value corresponding to the lower end position of the non-detection area may be set on the basis of a driving voltage applied to the motor 5 during raising of the movable member 2. Consequently, a pinch can be detected with higher accuracy than a case where the lower end position of the non-detection area is set on the basis of a pulse reference value corresponding to a reference position set at the last time when the movable member was opened or closed. Advantageously, if a narrower non-detection area is set, malfunction can be prevented and the pinch of a thinner object can be detected.

While the embodiments of the present invention have been described above, application of the present invention is not limited to the embodiments and a variety of applications can be made within the scope of its technical spirit. For example, as illustrated in FIG. 5 or 7, the relationship between the measured voltage and the difference in pulse value is used in the embodiments. The axis of abscissas in FIG. 5 or 7 may indicate a motor drive current or motor torque. Furthermore, in the embodiment, the lock detecting unit detects a change in torque on the basis of the period of pulses from each pulse generator. Instead, a current to drive the motor or a rate of change in current may be used.

What is claimed is:

1. A power window apparatus comprising:
a movable member that constitutes a window of a vehicle;
a motor that drives the movable member;
a pulse generator that generates a pulse as the motor rotates; and
a controller that controls the motor, wherein
the controller includes
reference position setting means for setting a pulse reference value corresponding to an upper-end lock position, serving as a reference position of the movable member,
position detecting means for detecting a level of the height of the movable member relative to the reference position by adding the number of pulses generated by the pulse generator to the pulse reference value,
lock detecting means for, on the basis of the period of pulses generated by the pulse generator, detecting a locked or unlocked state of the motor,
pinch detecting means for, in the case where the lock detecting means detects the locked state of the motor, determining, on the basis of whether the level of the height of the movable member detected by the position detecting means is positioned in a non-detection area set near the reference position, whether the movable member has reached the upper-end lock position or a pinch has occurred in the movable member, and
voltage detecting means for detecting a driving voltage applied to the motor, and
in the case where the pinch detecting means determines that the movable member has reached the upper-end lock position, the reference position setting means corrects the pulse reference value on the basis of the driving voltage applied to the motor detected by the voltage detecting means and sets the corrected value.

2. The apparatus according to claim 1, wherein the reference position setting means calculates, on the basis of a previously measured relationship between a voltage at the upper-end lock position and a difference in the number of pulses relative to the pulse reference value at a reference voltage, a difference in the number of pulses associated with the driving voltage applied to the motor detected by the voltage detecting means, adds the calculated difference in the number of pulses to the pulse reference value at the reference voltage, and sets the obtained value as the pulse reference value at the driving voltage.

3. The apparatus according to claim 1, wherein
the controller further includes area setting means for setting a pulse value corresponding to the position of the lower end of the non-detection area, and
while the movable member is being driven so as to be closed, the area setting means corrects the pulse value corresponding to the lower end position of the non-detection area on the basis of the driving voltage applied to the motor detected by the voltage detecting means and sets the corrected pulse value.

4. The apparatus according to claim 3, wherein the area setting means calculates, on the basis of a previously measured relationship between a voltage at the upper-end lock position and a difference in the number of pulses relative to the pulse reference value at a reference voltage, a difference in the number of pulses associated with the driving voltage applied to the motor detected by the voltage detecting means, adds the calculated difference in the number of pulses to the pulse value corresponding to the lower end position of the non-detection area at the reference voltage, and sets the obtained value as the pulse value corresponding to the lower end position of the non-detection area at the driving voltage.
